(19) United States
(12) Patent Application Publication
(10) Pub. No.: US 2001/0029494 A1
(43) Pub. Date: Oct. 11, 2001

(54) Computer readable recording medium recorded with electronic authorization program, electronically authorizing device and electronically authorizing method

(76) Inventor: Kazuhiko Tomita, Nagano (JP)

Correspondence Address: STAAS & HALSEY, Suite 500, 700 Eleventh Street, N.W., Washington, DC, 20001, US

(21) Appl. No.: 09/734,192

(22) Filed: Dec. 12, 2000

(30) Foreign Application Priority Data
Apr. 5, 2000 (JP) 2000-103556

(51) Int. Cl. G06F 17/60

(52) U.S. Cl. 705/67

(57) ABSTRACT

A computer readable recording medium recording an electronic authorization program, an electronically authorizing device and an electronically authorizing method, to enhance the efficiency and quality of the authorization work by preserving the authorization result in the database during the authorization work and making a reference thereto at any moment.

### BACKGROUND OF THE INVENTION

1. Field of the Invention

The present invention relates to technology of electronic authorization for authorizing or repudiating various tasks on a computer system and, particularly, to technology for improving the efficiency and quality of authorization work.

2. Related Art of the Invention

In recent years, a variety of tasks in companies and the like have been electronically processed owing to the introduction of computer systems. In carrying out the tasks, documents such as estimation sheets prepared by the person in charge are authorized by his superior before submitting the documents to the clients. In the tasks to be electronically processed, the authorization work, too, can be conducted on a computer.

In authorizing the documents, if mistakes having a tendency to be made by the person in charge have been known in advance, then, the documents can be checked by limiting the checking point to enhance the efficiency and quality of the authorization work.

According to the conventional authorization form, however, there are left only the results of authorization or repudiation of the documents. Or, even the results of authorization have not been left in many cases. Therefore, if the conventional authorization form is directly applied to the electronic processing, it is impossible to check the documents by limiting the point of issue, making it difficult to improve the efficiency and quality of the authorization work.

### SUMMARY OF THE INVENTION

In view of the above-mentioned problems inherent in the conventional technique, therefore, it is an object of the present invention to provide technology of electronic authorization in which the results of authorization in the authorization work are stored in a database, to be referred at any moment so that efficiency and quality of authorization work are improved.

In order to accomplish the above object, according to the electronic authorization technology of the present invention, when an object requesting authorization is to be authorized or repudiated, a result of authorization is registered in the database, and a reference is made to the past results of authorization registered in the database for each of the objects requesting authorization and of the persons requesting authorization.

According to this constitution, when the object requesting authorization is to be authorized or repudiated, the result of authorization is registered in the database. When, for example, the object requesting authorization is to be authorized or repudiated, a reference can be made to the past results of authorization registered in the database for each the objects requesting authorization and of the persons requesting authorization. Therefore, a authorizing person authorizes or repudiates the object requesting authorization, makes a reference to the past results of authorization for each of the objects requesting authorization and of the persons requesting the authorization, to easily grasp mistakes having a tendency to be made by the person requesting authorization. As a result, the authorizing person is possible to check the object requesting authorization by limiting the checking point and, hence, to improve the efficiency and quality of the authorization work. The same also holds when the person requesting authorization prepares or amends the object requesting authorization, or when the person requesting authorization requests the authorization upon the object requesting authorization.

Further, even when the authorizing person is changed due to personnel changes, the tendency of repudiation on the persons requesting authorization or on the objects requesting authorization can be easily grasped, suppressing a drop in the efficiency and quality of the authorization work.

Further, when mistakes frequently happen concerning particular persons requesting authorization or particular objects requesting authorization, the cause of mistakes is often found out by making a reference to the past results of authorization. Then, the person requesting authorization can be informed of this fact to correct the problem.

According to the above-mentioned operation, the frequency for conducting the authorization processing can be decreased, and the time required for the authorization work and the cost can be decreased.

When various functions for realizing the above electronic authorization are recorded in a computer readable recording medium, then, an electronically authorizing device according to the present invention can be easily built up using a general computer.

Here, the “recording medium” is the one which is capable of reliably recording various information therein and from which the data can be taken out as required, such as a magnetic tape, a magnetic disk, a magnetic drum, an IC card, a CD-ROM, a DVD-ROM, etc.

It is desired that, concerning the object requesting authorization, the result of authorization or repudiation is registered in the database, and, in the case of repudiation, the reason for repudiation is registered in the database.

According to this constitution, in the database are registered the results of authorization or repudiation and, in the case of repudiation, the reason for repudiation concerning the object requesting authorization. Accordingly, the past tendency of authorization or repudiation can be easily grasped concerning the persons requesting authorization or the objects requesting authorization, enabling the authorization work to be efficiently carried out.

It is further desired that a reference can be made to the accumulated number of cases depending upon authorization or repudiation and to the accumulated number depending upon the repudiation reasons during a predetermined period of time in connection with the past results of authorization registered in the database.

According to this constitution, a reference is made to the accumulated number of cases depending upon authorization or repudiation and to the accumulated number depending upon the repudiation reasons during the predetermined period of time when a reference is made to the results of authorization registered in the database. Accordingly, the past tendency of authorization or repudiation is grasped through the accumulated number of cases, so that the tendency of reasons that have led to the repudiation can be easily grasped.

It is further desired to make a reference, in the form of a chart, to the ratio of the repudiation reasons during a predetermined period of time in connection with the past results of authorization registered in the database.

According to this constitution, a reference is made, in the form of a chart, to the ratio of the repudiation reasons during the predetermined period of time and, hence, the tendency of repudiation can be grasped at a glance.

The other objects and aspects of the present invention will become apparent from the following description of embodiments in connection with the accompanying drawings.

### BRIEF DESCRIPTION OF THE DRAWINGS

FIG. 1 is a diagram illustrating one embodiment of the whole constitution of an electronically authorizing device according to the present invention;

FIG. 2 is a diagram illustrating authorization information stored in an authorization information database, wherein FIG. 2A is an authorization request table, and FIG. 2B is an explanatory diagram of a table of objects requesting authorization;

FIG. 3 is an explanatory diagram of a repudiation reason setting table in which the repudiation reasons are set;

FIG. 4 is an explanatory diagram illustrating the outline of the authorization work carried out by using the electronically authorizing device;

FIG. 5 is an explanatory diagram of an actual authorization result reference screen in an initial state;

FIG. 6 is an explanatory diagram of the actual authorization result reference screen displaying the actual results of authorization in an expanded manner;

FIG. 7 is a flowchart explaining the contents of processing on the actual authorization result screen;

FIG. 8 is an explanatory diagram of an authorization request processing screen;

FIG. 9 is a flowchart explaining the contents of processing on the authorization request processing screen;

FIG. 10 is an explanatory diagram of a repudiated object list;

FIG. 11 is an explanatory diagram of an authorization processing screen;

FIG. 12 is a flowchart explaining the contents of processing on the authorization processing screen; and

FIG. 13 is a diagram illustrating another embodiment of the whole constitution of the electronically authorizing device according to the present invention.

### DESCRIPTION OF THE PREFERRED EMBODIMENTS

The present invention will now be described in detail with reference to the accompanying drawings.

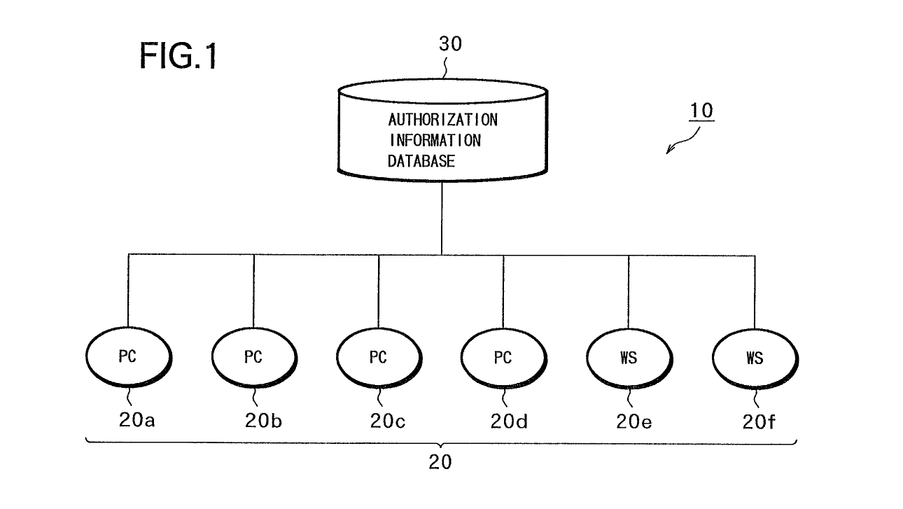

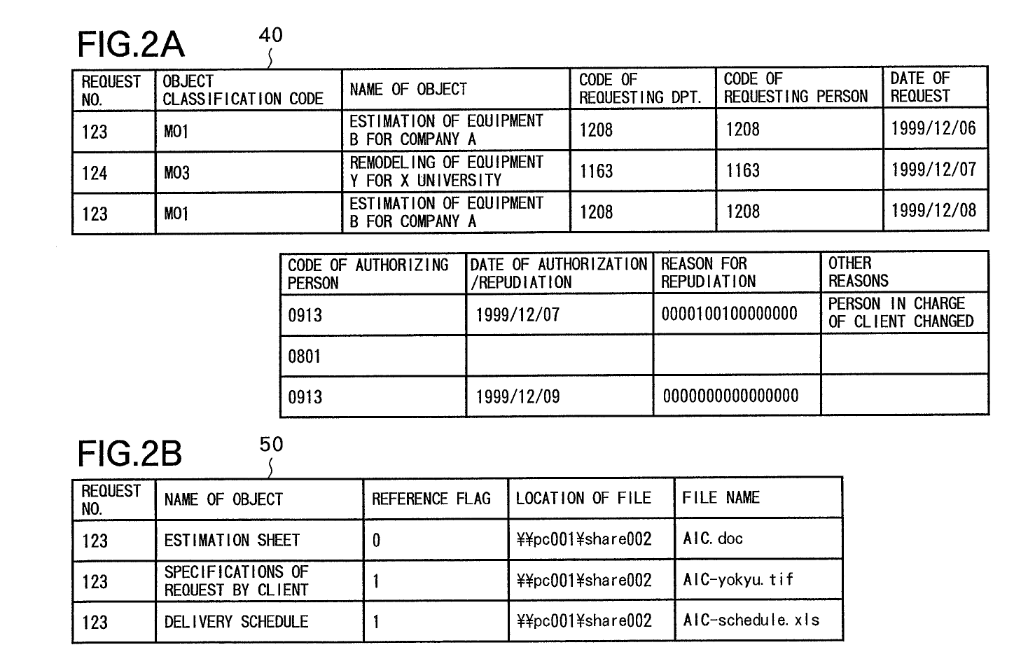

As shown in FIG. 1, an electronically authorizing device 10 includes at least one terminal 20 (20a to 20f), and an authorization information database (hereinafter referred to as “authorization information DB”) 30. The terminal 20 is constituted by at least a central processing unit (CPU), a PC (personal computer) or a WS (work station) equipped with a memory and a display, and executes various processings according to a program loaded in the memory. As shown in FIG. 2, the authorization information DB 30 stores an authorization request table 40 and an authorization request object table 50, as authorization information.

The terminal 20 realizes by software an authorization result registration function, authorization result registration means, an authorization result registration process, an authorization result reference function, authorization result reference means, and an authorization result reference process.

As shown in FIG. 2A, the authorization request table 40 includes request numbers, object classification codes, object names, codes of requesting departments, codes of requesting persons, dates of request, codes of authorizing persons, dates of authorization/repudiation, reasons for repudiation, and other reasons. The request number is information for specifying the object requesting authorization, and is described using a unique integer attached to each object requesting authorization. The object classification code is information for specifying what is the object requesting authorization, and is described using a unique character sequence attached to each object requesting authorization, for example, “M01” which represents an estimation sheet. The object name is information expressing the name of object requesting authorization, and is described using an arbitrary character sequence. The code of requesting department is information for specifying a department (e.g., business department) to which a person requesting authorization belongs, and is described by using a unique character sequence attached to each department. The code of requesting person is information for specifying a person requesting authorization, and is described by using a unique character sequence attached to each person requesting authorization. The date of request is information for specifying the date of requesting authorization, and is described, for example, in a date expressing form used in a system. The code of authorizing person is information for specifying a person who checks an object requesting authorization and renders the authorization or repudiation, and is described by using a unique character sequence attached to each authorizing person. The date of authorization/repudiation is information for specifying the date of authorizing or repudiating the object requesting authorization, and is described, for example, in a date expressing form used in the system like the date of request. When the date of authorization/repudiation has not been set, it means that the object requesting authorization has not been authorized. The reason for repudiation is information for specifying by what reason the object requesting authorization was repudiated, and is described by using a sequence of bits expressed by 0 or 1. Other reason is information representing a repudiation reason that does not pertain to the repudiation reasons that can be generally classified, and is described by using an arbitrary character sequence.

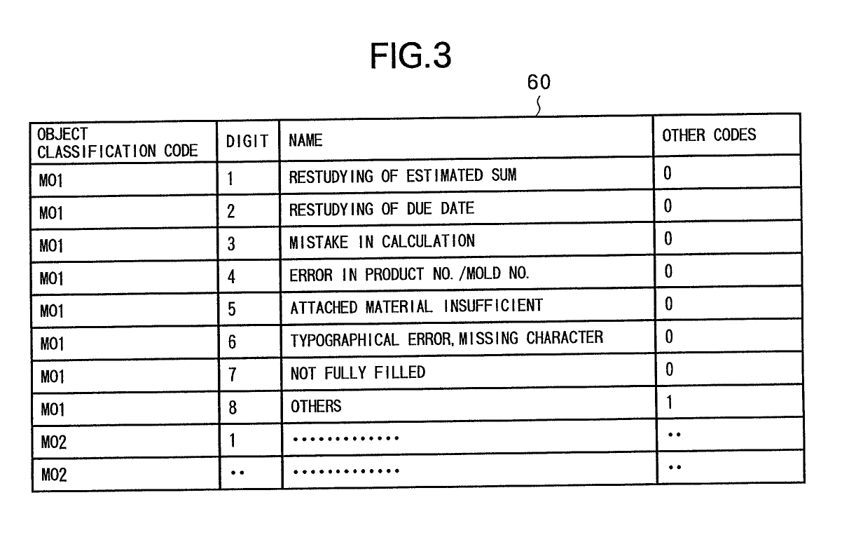

Here, as shown in FIG. 3, the repudiation reason can be arbitrarily set by using a repudiation reason setting table 60 in which are set a digit, a name and other code for each object classification code. That is, on a screen for setting the repudiation reasons, that is not shown, the repudiation reason setting table 60 is automatically formed by designating a digit for specifying the position from the head of the bit sequence representing the repudiation reasons, designating a name representing the repudiation reason, and designating a code representing the accompaniment of other reasons, for each object classification code. When the past results of authorization are to be displayed, the repudiation reason setting table 60 is read and analyzed to display an arbitrary repudiation reason for each object requesting authorization.

As shown in FIG. 2B, on the other hand, the authorization request object table 50 includes request numbers, object names, reference flags, locations of files and file names. The request number is information same as the request number included in the table authorization request table 40. The object name is information for specifying the object requesting authorization and the object annexed thereto, and is described by using an arbitrary character sequence. The reference flag is information for specifying whether it is the object requesting authorization or the object annexed thereto, and is described by a bit expressed by 0 (object requesting authorization) or 1 (annexed object). The location of file is information for specifying the place where the object requesting authorization or the annexed object is preserved, and is described by an arbitrary character sequence. The file name is information for specifying the object requesting authorization or the object annexed thereto, and is described by an arbitrary character sequence.

When the request number is designated, therefore, the authorization request object table 50 is retrieved with the request number as a key, making it possible to specify what are the object requesting authorization and the object annexed thereto. When it is desired to see entities of the object requesting authorization and the object annexed thereto, the applications adapted to the respective objects are automatically started based on the location of file and the file name set in the authorization request object table 50, as will be described later.

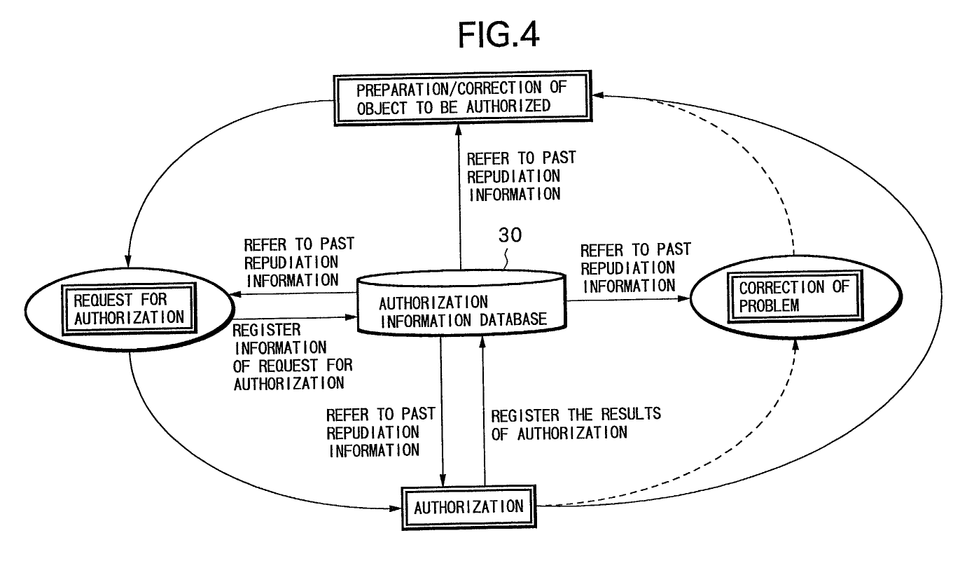

FIG. 4 shows the outline of authorization work for the object requesting authorization, such as an estimation sheet by using the electronically authorizing device 10.

When a person in charge prepares or corrects an object requesting authorization, a reference is made to information of past repudiations accumulated in the authorization information DB 30. The information of past repudiations includes information accumulating, for each person in charge, the reasons (such as mistakes in the calculation) why the objects to be authorized were repudiated in the past. If the person in charge makes a reference to the repudiation information, it is possible for him to easily grasp mistakes that are likely to be made and, hence, by paying his attention thereto, to prepare or correct the object requesting authorization with a high quality.

Also, when the person in charge requests the authorization, the information of past repudiations is referred to. In this case, the object to be authorized is checked again, and the authorization can be requested for an object to be authorized with less mistakes. After the object to be authorized has been checked, the authorization request information is registered in the authorization information DB 30. The authorizing person is informed of the fact that the person in charge has requested the authorization through, for example, e-mail.

When the authorizing person renders the authorization or the repudiation for the object to be authorized, a reference is made to the information of past repudiations accumulated in the authorization information DB 30. If the authorizing person makes a reference to the repudiation information, it is possible for him to easily grasp by what reason the person in charge who has requested the authorization was repudiated and, hence, by checking concentratedly the items that were causes of repudiation, the efficiency when rendering authorization or repudiation can be improved. When the object to be authorized is authorized or repudiated, the authorization information or the repudiation information as the result of authorization, are registered in the authorization information DB 30. The result of authorization is referred to at the time of preparing or correcting the object to be authorized, at the time of requesting the authorization and at the time of next authorization work, as described earlier.

The information of past repudiations registered in the authorization information DB 30 can be referred to at any moment. That is, when the mistake has not been corrected despite the person in charge makes a reference to the information of past repudiations, then, the authorizing person investigates various preventive measures based upon the information of past repudiations. If there is a cause limited to the person in charge or to the object to be authorized, the preventive measure is such that this person in charge is informed of the cause to be corrected to solve the problem.

Next, described below is the content of processing in the electronically authorizing device 10.

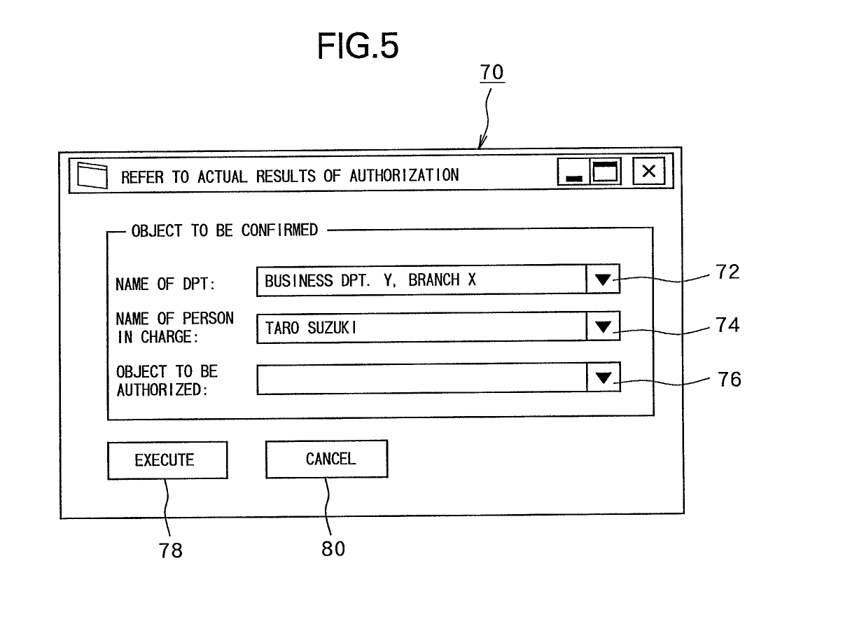

When the information of past repudiations is to be referred to in preparing or correcting the object to be authorized and in solving the problem, an actual authorization result reference screen 70 is displayed as shown in FIG. 5. The actual authorization result reference screen 70 includes a portion 72 for designating the name of department, a portion 74 for designating the name of person in charge, a portion 76 for designating the object to be authorized, an “EXECUTION” button 78 and a “CANCEL” button 80.

The actual authorization result reference screen 70 serves as an actual authorization result reference function, actual authorization result reference means and an actual authorization result reference process.

At the portion 72 for designating the name of department, the name of a department to which the person in charge as the person requesting authorization belongs, is designated. At the portion 74 for designating the name of person in charge, the name of a person in charge as the person requesting authorization is designated. At the portion 76 for designating the object to be authorized, the name of an estimation sheet or the like as the object to be authorized is designated. Here, the portion 72 for designating the name of department, the portion 74 for designating the name of person in charge and the portion 76 for designating the object to be authorized, are built up by list boxes of drop-down form, respectively, so that the name of department, the name of person in charge and the object to be authorized can be selected out of those indicated on the lists other than the direct entry of character sequences.

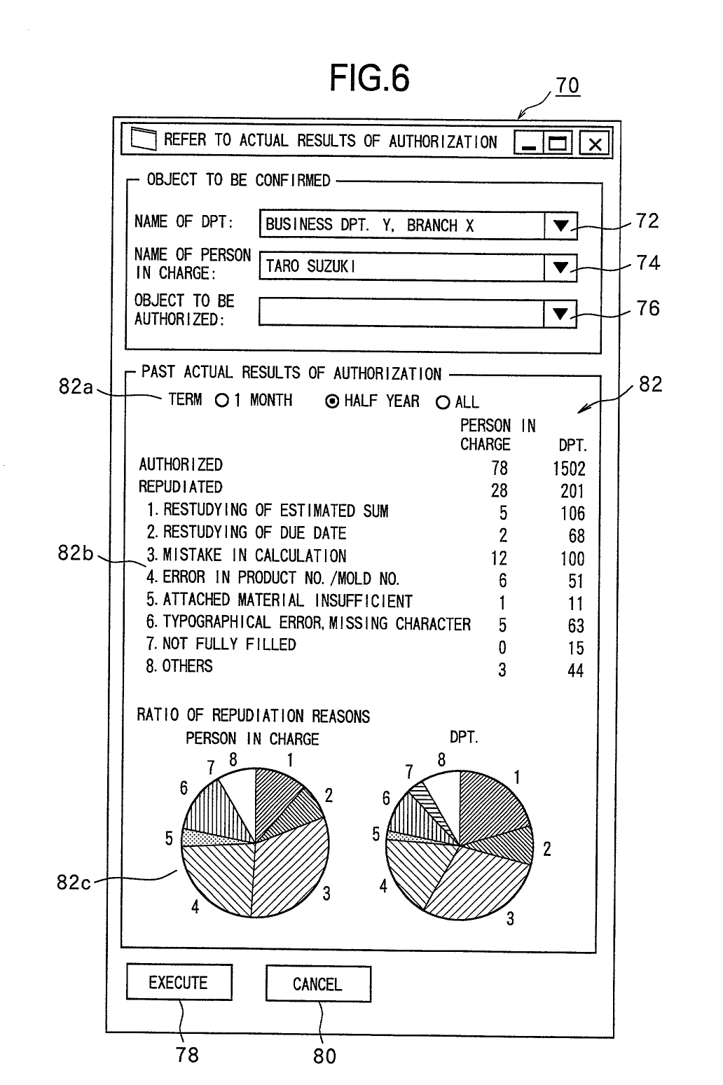

Then, after the name of the estimation sheet or the like as the object to be authorized is entered to the portion 76 for designating the object to be authorized, when the “EXECUTION” bottom 78 is depressed, then, as shown in FIG. 6, an actual authorization result display portion 82 is displayed in an expanded manner corresponding to the object to be authorized. The actual authorization result display portion 82 includes a portion 82a for designating the term, a portion 82b for displaying the totalized result, and a graphic display portion 82c. In the portion 82a for designating the term, the term (hereinafter referred to as “designated term”) for accumulating the authorization results is designated through a radio button. The portion 82b for displaying the totalized result displays the number of authorized cases, the number of repudiated cases, and the accumulated number of repudiation reasons within the designated term for each person in charge and for each department to which the person in charge belongs. The graphic display portion 82c displays a pie chart representing a ratio of repudiation reasons within the designated term. In this embodiment, the ratio of the repudiation reasons is expressed by a pie chart. However, the ratio of repudiation reasons may be expressed by a bar chart, a polygonal line chart or the like.

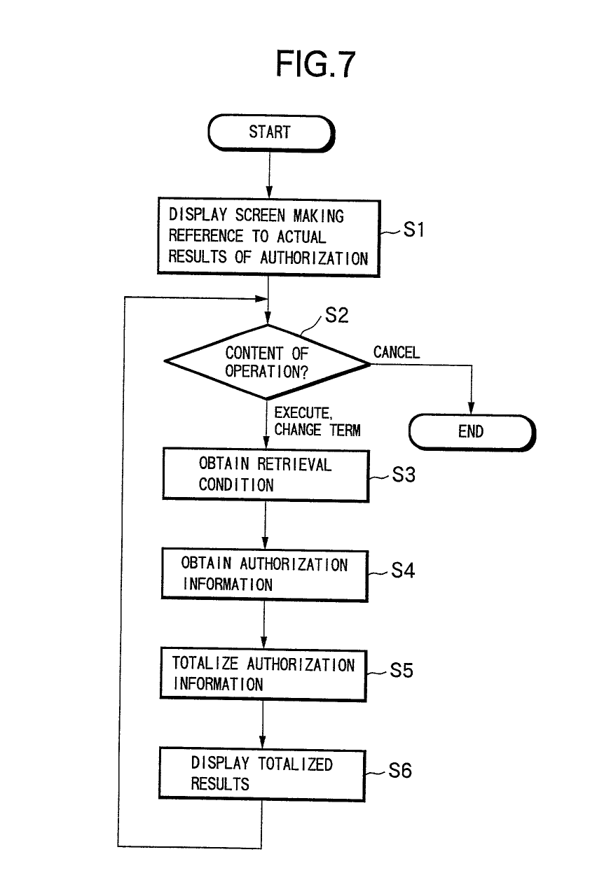

FIG. 7 is a flowchart illustrating the content of processing on the actual authorization result reference screen 70. The flowchart of FIG. 7 corresponds to the authorization result reference function, authorization result reference means and the authorization result reference process.

At step 1 (abbreviated as “S1” in the figure, the same holds hereinafter), the actual authorization result reference screen 70 shown in FIG. 5 is displayed as an initial screen. The portion 72 for designating the name of department and the portion 74 for designating the name of person in charge, display, as default, the name of a department to which the operator of the terminal 20 belongs and the name of the operator, respectively. The portion 76 for designating object to be authorized displays the object to be authorized in a state of undesignated. Here, the name of the operator and the like of the terminal 20 are determined based on information of when the log-in is accomplished at the respective terminals.

At step 2, the branch processing according to the content of processing is executed based upon an event message notified from an operating system (hereinafter referred to as “OS”). That is, when the “EXECUTION” button 78 is depressed or when the portion 82a for designating the term is operated to change the designated term, the routine proceeds to step 3. When the “CANCEL” button 80 is depressed, the processing on the actual authorization result reference screen 70 is terminated.

At step 3, retrieval conditions are obtained for retrieving the authorization information DB 30. That is, on the actual authorization result reference screen 70 shown in FIG. 5, the name of department, the name of person in charge and the object to be authorized are obtained from the portion 72 for designating the name of department, from the portion 74 for designating the name of person in charge and from a portion 7 for designating the object to be authorized, respectively. On the actual authorization result reference screen 70 shown in FIG. 6, on the other hand, the designated term is obtained from the portion 82a for designating the term, in addition to the name of department, name of person in charge and the object to be authorized.

At step 4, the authorization information DB 30 is retrieved with the obtained retrieval conditions as a key, to thereby obtain authorization information that meets the retrieval conditions.

At step 5, the number of authorized cases, the number of repudiated cases and the accumulated number for each repudiation reason in the person in charge and in the department, are totalized based on the obtained authorization information. Here, the number of authorized cases and the number of repudiated cases are totalized by accumulating the number of cases in which “authorization” is rendered when the whole bits are 0 based on the repudiation reasons in the authorization request table 40 shown in FIG. 2A, and “repudiation” is rendered when at least any one bit is 1. On the other hand, the number of cases for each of the repudiation reasons are totalized by separately accumulating the case in which the bit of repudiation reason is 1.

At step 6, the totalized result is displayed on the portion 82b for displaying the totalized result based on the totalized result, and a pie chart is displayed on the graphic display portion 82c to represent the ratio of the repudiation reasons. In the portion 82b for displaying the totalized result, the display items are displayed based on the repudiation reason setting table 60 shown in FIG. 3.

According to the above-mentioned processing at steps 1 to 6, the authorization information DB 30 is retrieved with the name of department, name of person in charge, object to be authorized and term designated by the operator as retrieval conditions, and the authorization information that meets the retrieval conditions is obtained. Then, the obtained authorization information is totalized, and the totalized result is displayed as the actual authorization result. At this time, if the operator changes the designated term or the like, the authorization result corresponding to the change is displayed.

In preparing or correcting the object to be authorized, therefore, it is possible to easily make a reference to the past actual authorization result and, hence, to prepare or correct the object to be authorized with less formal mistakes by paying attention to the items that involve frequent mistakes. In solving the problems, on the other hand, since it is possible to easily grasp the mistakes that are liable to be made by the person in charge, the person in charge is informed of this fact to pay attention. The person in charge pays attention to the items that involve frequent mistakes, so that there can be prepared the object to be authorized with less formal mistakes.

In this way, if the object to be authorized is formed with less formal mistakes, the authorizing person who checks it to render the authorization or the repudiation needs simply check the essential contents, enhancing the efficiency and quality of the authorization work.

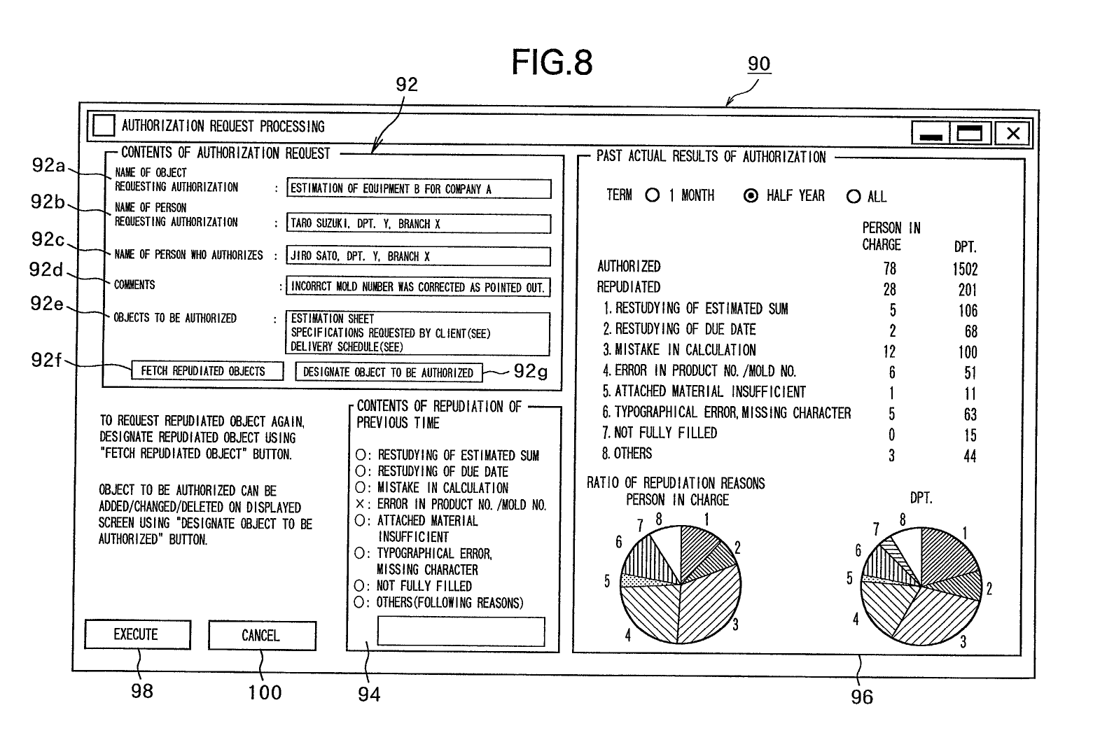

In requesting the authorization, when a reference is made to the past repudiation data, there is displayed an authorization request processing screen 90 as shown in FIG. 8. The authorization request processing screen 90 includes a portion 92 for designating the content of authorization request, a portion 94 for displaying the repudiation content, a portion 96 for displaying the actual authorization result, an “EXECUTION” button 98 and a “CANCEL” button 100.

The authorization request processing screen 90 serves as an authorization result reference function, authorization result reference means and an authorization result reference process.

The portion 92 for designating the content of authorization request exhibits a function of specifying the object to be authorized, and includes a portion 92a for designating the name of object requesting authorization, a portion 92b for designating the name of person requesting authorization, a portion 92c for designating the name of authorizing person, a portion 92d for entering comments, a portion 92e for designating the object to be authorized, a “fetch the repudiated object ” button 92f, and a “designate an object to be authorized” button 92g. At the portion 92a for designating the name of object requesting authorization, the name of object requesting authorization is designated. At the portion 92b for designating the name of person requesting authorization, the name of person requesting authorization is designated. At the portion 92c for designating the name authorizing person, the name of authorizing person who renders the authorization or the repudiation on the object to be authorized is designated. At the portion 92d for entering comment, a comment to be informed to the authorizing person is entered, as required. At the portion 92e for designating the object to be authorized, the object to be authorized and the object annexed thereto are designated. The object to be authorized and the object annexed thereto are registered in the authorization request object table 50 of shown in FIG. 2B.

At the portion 94 for displaying the repudiation content, the content repudiated in the previous time in connection with the object requesting authorization specified at the portion 92 for designating the content of authorization request is displayed. At this time, in the other item, a comment entered by the authorizing person is displayed. When the authorization request for the object to be authorized is for the first time, the portion 94 for displaying the repudiated content may be displayed in a gray color or may not be displayed, and the reasons for repudiation may be expressed as “-” as can be comprehended.

The portion 96 for displaying the actual authorization result is the same as the above-mentioned actual authorization result reference screen 70 (see FIG. 6), and the explanation thereof is omitted.

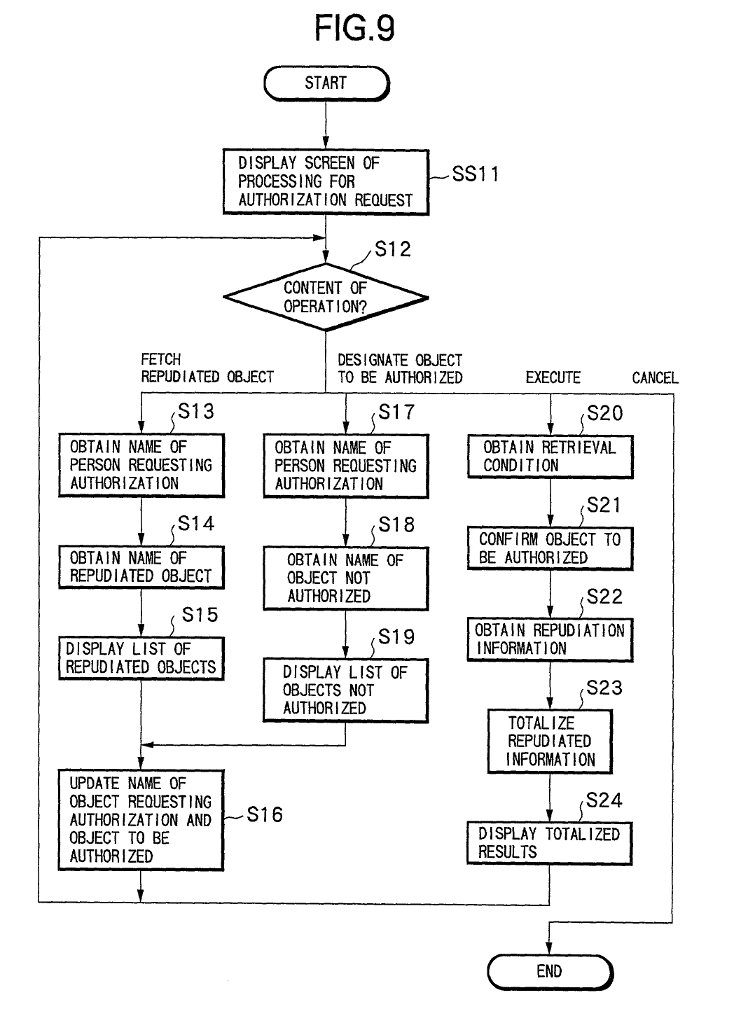

FIG. 9 is a flowchart explaining the content of processing in the authorization request processing screen 90. The flowchart shown in FIG. 9 corresponds to an authorization result reference function, authorization result reference means and an authorization result reference process.

At step 11, the authorization request processing screen 90 shown in FIG. 8 is displayed. At the portion 92 for designating the content of authorization request in an initial state, the name of the operator the terminal 20 as the name of person requesting authorization of default is displayed and other items are displayed in a state of not being designated. In this case, since the object requesting authorization has not been determined, the content is displayed neither at the portion 94 for displaying the repudiated content nor at the portion 96 for displaying the actual authorization result.

At step 12, the branching processing is executed depending upon the content of processing based on an event message from the OS. That is, the routine proceeds to step 13 when the “fetch the repudiated object” button 92f is depressed, while the routine proceeds to step 17 when the “designate the object to be authorized” button 92g is depressed. Further, the routine proceeds to step 20 when the “EXECUTION” button 98 is depressed, and the processing on the authorization request processing screen 90 is terminated when the “CANCEL” button 100 is depressed.

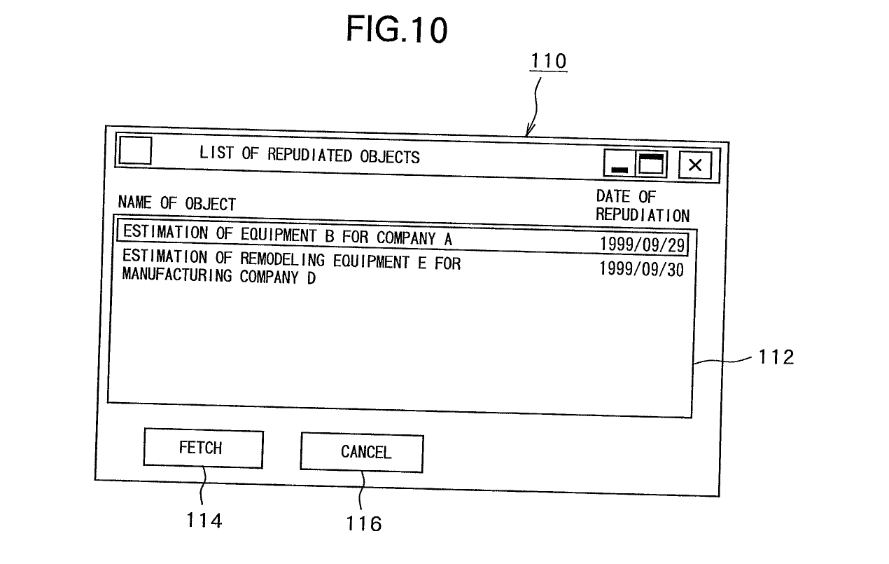

At steps 13 to 16, a work is carried out to select the repudiated object out of a plurality of objects to be authorized registered in the authorization information DB 30 in order to again request authorization for the objects repudiated in the past. That is, at step 13, the name of person requesting authorization is obtained from the portion 92 for designating the content of requesting the authorization. At step 14, the authorization information DB 30 is retrieved with the obtained name of person requesting authorization as a retrieval condition to obtain the object repudiated in the past. At step 15, as shown in FIG. 10, a repudiated object list screen 110 for displaying a list of the names of the repudiated objects is displayed.

The repudiated object list screen 110 includes a portion 111 for displaying the names of objects, a “FETCH” button 114 and a “CANCEL” button 116. To select a repudiated object on the repudiated object list screen 110, a desired repudiated object is designated among the repudiated objects displayed on a portion 112 for displaying the name of object by using a mouse or the like, and the “FETCH” button 114 is depressed. To discontinue the selection of the repudiated object, the “CANCEL” button 116 is depressed.

At step 16, the name of the object requesting authorization and the object to be authorized are updated in the portion 92 for designating the content of authorization request based on the selected object requesting authorization. Here, the content in the portion 92e for designating the object to be authorized is determined by retrieving the authorization request object table 50 (see FIG. 2B) registered in the authorization information DB 30. The routine then returns back to step 12 where the processing is continued according to the content of operation.

At steps 17 to 19, the processing of when the “designate the object to be authorized” button 92g is depressed is executed. Namely, in order to request authorization for a new object to be authorized, a work is carried out to select an object to be authorized out of the objects to be authorized registered in the authorization information DB 30. Concretely speaking, at step 17, the name of person requesting authorization is obtained from the portion 92 for designating the content of authorization request. At step 18, the authorization information DB 30 is retrieved with the obtained name of person requesting authorization as a retrieval condition, to thereby obtain the name of unauthorized object as a new object to be authorized. At step 19, the unauthorized object list screen for displaying a list of the names of the unauthorized objects is displayed. The unauthorized object list screen is substantially the same as the repudiated object list screen 110 shown in FIG. 10, and the figure and explanation thereof is omitted. Here, the object to be authorized can be added, changed or deleted on the unauthorized object list screen. Then, the routine proceeds to step 16 where the name of object requesting authorization and the object to be authorized are updated based on the name of the selected unauthorized object.

At steps 20 to 24, the processing of when the “EXECUTION” button 98 is depressed is executed. That is, the authorization information DB 30 is retrieved with the item designated at the portion 92 for designating the content of authorization request as a retrieval condition, to update the repudiated content of the previous time and the past actual authorization result. Concretely speaking, at step 20, the name of object requesting authorization, the name of person requesting authorization and the name of authorizing person are obtained from the portion 92 for designating the content of authorization request. At step 21, the object to be authorized which was specified by the obtained name of object requesting authorization, is checked. That is, a priori check program considered necessary is called by using a so-called outlet function to determine whether the object to be authorized is proper. When the object to be authorized is not proper, a message box or the like is displayed to inform of this fact. At step 22, the authorization information DB 30 is retrieved with the name of the obtained object requesting authorization as a retrieval condition, to thereby obtain the authorization information that meets the retrieval condition. At step 23, like at step 5, the number of authorized cases, the number of repudiation cases and the accumulated number of each of repudiation reasons in each person in charge and in each department, are respectively totalized. At step 24, the repudiated content of the previous time is displayed on the portion 94 for displaying the repudiated content based on the obtained authorization information, and the totalized result is displayed on the portion 96 for displaying the actual authorized result based on the totalized result. Then, the routine returns back to step 12 to continue the processing according to the content of operation.

According to the processing at steps 11 to 24, the person in charge as the person requesting authorization is possible to make a reference to the repudiation reason of the previous time and the past actual authorization result when he requests authorization on an object to be authorized. Therefore, the person in charge is possible to grasp mistakes that are liable to be made by him and, hence, to request authorization on an object to be authorized with less formal mistakes. In this case, the authorizing person only needs check mainly the substantial contents to enhance the authorization efficiency and quality thereof.

On the authorization request processing screen 90 shown in FIG. 8, the “fetch the repudiated object” button 92f or “designate the object to be authorized” button 92g was depressed at the time of designating the name of object requesting authorization. It is, however, also allowable to directly enter the name of object requesting authorization to the portion 92a for designating the name of object requesting authorization.

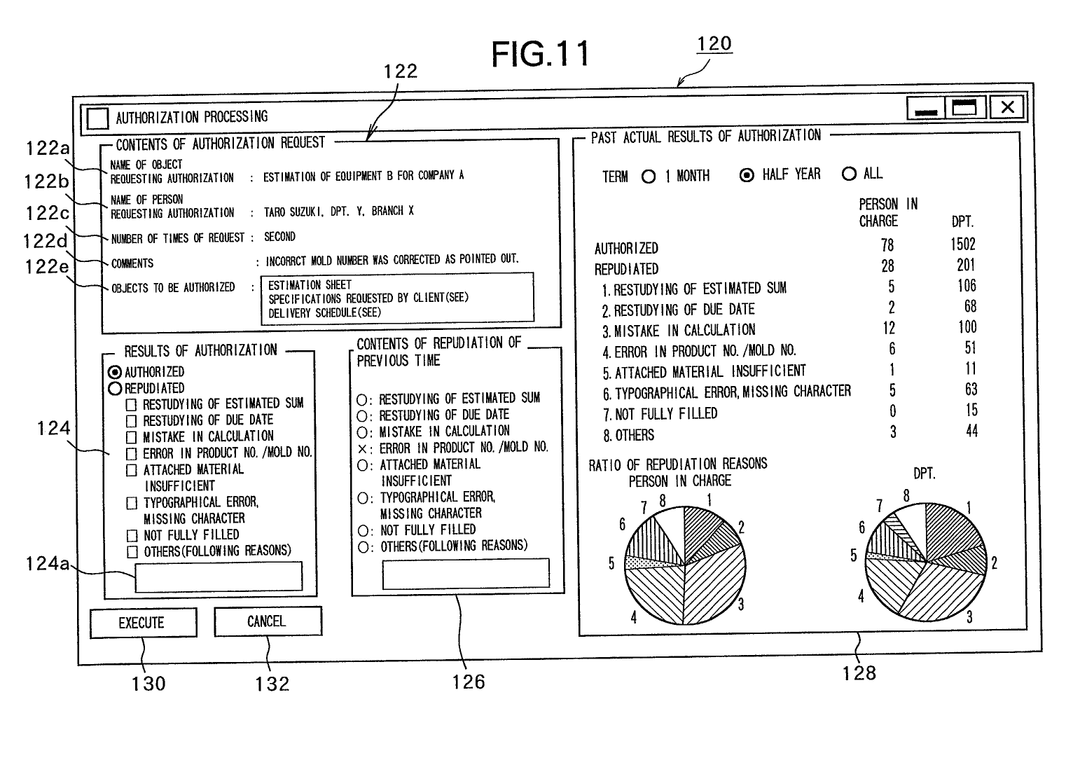

When the authorizing person makes a reference to the past repudiation information, there is displayed an authorization processing screen 120 as shown in FIG. 11. The authorization processing screen 120 includes a portion 122 for displaying the content of authorization request, a portion 124 for entering the authorization result, a portion 126 for displaying the repudiated content, a portion 128 for displaying the actual authorization result, an “EXECUTE” button 130 and a “CANCEL” button 132.

The authorization processing screen 120 serves as an authorization result registration function, authorization result registration means, an authorization result registration process, an authorization result reference function, authorization result reference means and a authorization result reference process.

The portion 122 for displaying the content of authorization request exhibits a function of confirming the object to be authorized, and includes a portion 122a for displaying the name of object requesting authorization, a portion 122b for displaying the name of person requesting authorization, a portion 122c for displaying the number of times of request, a portion 122d for displaying comment, and a portion 122e for displaying the object to be authorized. The name of object requesting authorization and the name of person requesting authorization, are displayed on the portion 122a for displaying the name of object requesting authorization and on the portion 122b for displaying the person requesting authorization, respectively. The portion 122c for displaying the number of times of request displays how many times of requests the request for authorization of this time is. The number of times of requests is specified by counting the same request numbers by analyzing the request numbers in the authorization request table 40 shown in FIG. 2A. On the portion 122d for displaying comment, a comment entered by the person requesting authorization on the authorization request processing screen 90 shown in FIG. 8 is displayed. On the portion 122e for displaying the object to be authorized, the object requesting authorization and the object annexed thereto are displayed. A double click using a mouse or the like starts the application adapted to the format of each of the object to make it possible to confirm what it is.

The authorization result entering portion 124 exhibits a function of entering the result checked by the authorizing person of the object to be authorized. Thus, the authorization or the repudiation is entered as a result of authorization. When the repudiation is made, the reasons thereof are entered. Here, concerning the other reasons, the portion 124a for entering comment is provided for entering the comments of the authorizing person.

The portion 126 for displaying the repudiated content and the portion 128 for displaying the actual authorization result are the same as the above-mentioned actual authorization result reference screen 70 (see FIG. 6) and the authorization request processing screen 90 (see FIG. 8), and the explanations thereof are omitted.

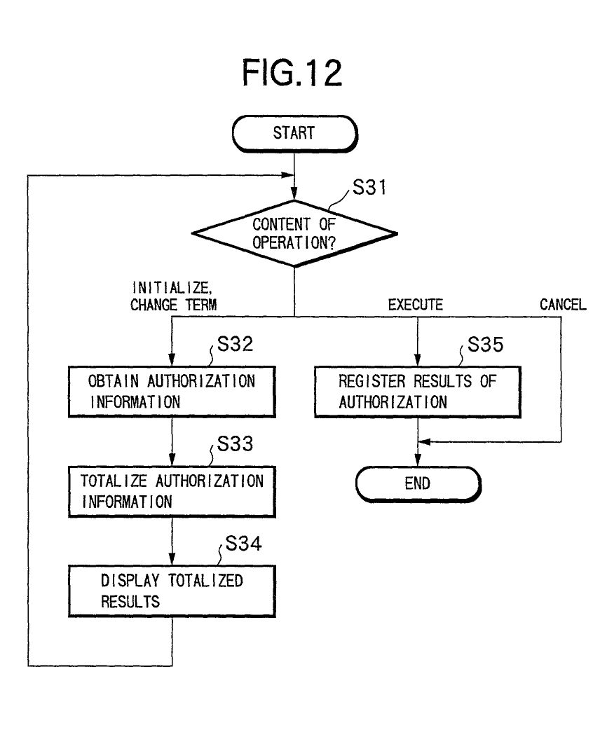

FIG. 12 is a flowchart explaining the content of processing on the authorization processing screen 120.

At step 31, a branch processing is executed according to the content of processing based on an event message from the OS. That is, when the authorization processing screen 120 of an initial state is displayed, or when the designated term is changed, the routine proceeds to step 32. When the “EXECUTION” button 130 is depressed, the routine proceeds to step 35 and when the “CANCEL” button 132 is depressed, the processing on the authorization processing screen 120 is terminated.

At steps 32 to 34, the authorization processing screen 120 is displayed or the updating processing is executed. That is, at step 32, the authorization information DB 30 is retrieved with the name of the person requesting authorization and the name of the object requesting authorization which were designated at the start of the authorization processing as retrieval conditions, to thereby obtain the authorization information related to the object requesting authorization. At step 33, the number of times of request concerning the object to be authorized is counted based on the obtained authorization information. Further, the number of authorization cases, the number of repudiation cases and the accumulated number of each of repudiation reasons for each person in charge and in each department, are totalized respectively, in the designated term (default term in the case of the initial display). At step 34, the content of authorization request, the repudiated content of the previous time, and the past actual authorization result are displayed. Here, when the object requesting authorization is a new one, the repudiation content of the previous time is not displayed. Then, the routine returns back to step 31 to continue the processing according to the content of operation.

The processing at steps 31 to 34 correspond to the authorization result reference function, the authorization result reference means and the authorization result reference process.

At step 35, there is executed the processing of when the “EXECUTION” button 130 is depressed. That is, when the authorizing person checks the object to be authorized and decides to render the authorization or the repudiation, the result is entered to the authorization result entering portion 124. When the authorizing person depresses the “EXECUTION” button 130, the authorization result is obtained from the authorization result entering portion 124 to be registered to the authorization information DB 30 in a form as shown in FIG. 2.

The processing at step 35 corresponds to the authorization result registration function, the authorization result registration means and the authorization result registration process.

According to the above-mentioned processing of steps 31 to 35, the authorizing person is possible to refer to the past result of authorization concerning the object to be authorized and, hence, to easily grasp mistakes which are liable to be made by the person requesting authorization. Therefore, the authorizing person is possible to carry out the focused checking to efficiently conduct the authorization work and improving the quality of his work. The results of authorization, i.e., the authorization information or the repudiation information are registered in the authorization information DB 30 and are referred to at the time of preparing or correcting the object to be authorized next time, or at the time of requesting authorization and at the time of rendering the authorization.

The repudiation information referred to in the electronically authorizing device 10 is not only useful in preparing or correcting the object requesting authorization, in requesting the authorization, in rendering the authorization and in solving the problems but is also helpful for taking a preventive countermeasure for ISO9001.

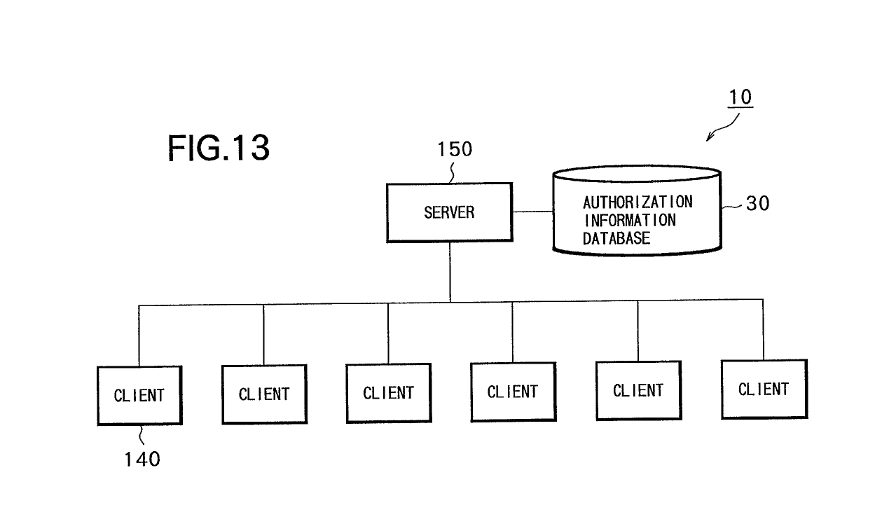

As shown in FIG. 13, further, the above-mentioned electronically authorizing device 10 may be built up on a computer system of a client/server model. Further, the authorization information DB 30 may be built up on, for example, a distributed file system shared by clients 140 and a server 150.

If a program for realizing such a function is recorded on a computer readable recording medium, such as a magnetic tape, a magnetic disk, a magnetic drum, an IC card, a CD-ROM or a DVD-ROM, then, the electronic authorization program according to the present invention can be put into the market. Then, a person who obtained such a recording medium is possible to easily build up the electronically authorizing device according the present invention by using a general computer.

1. A computer readable recording medium recorded with an electronic authorization program, for realizing on a computer:
an authorization result registration function of registering a result of authorization in a database when an object requesting authorization is to be authorized or repudiated; and
an authorization result reference function of making a reference to the past results of authorization registered in the database for each object requesting authorization and for each person requesting authorization.

2. A computer readable recording medium recorded with an electronic authorization program according to claim 1, wherein said authorization result registration function registers, in the database, said result of authorization or repudiation for said object requesting authorization, and repudiation reasons when the repudiation is rendered.

3. A computer readable recording medium recorded with an electronic authorization program according to claim 2, wherein said authorization result reference function makes a reference to accumulated number of cases of authorization or repudiation and accumulated number of cases of the repudiated reasons within a predetermined term concerning the past results of authorization registered in the database.

4. A computer readable recording medium recorded with an electronic authorization program according to claim 2, wherein said authorization result reference function makes a reference to a ratio of the repudiated reasons during a predetermined term in the form of a chart concerning the past results of authorization registered in the database.

5. An electronically authorizing device comprising:
authorization result registration means for registering a result of authorization in a database when an object requesting authorization is to be authorized or repudiated; and
authorization result reference means for making a reference to the past results of authorization registered in the database for each object requesting authorization and for each person requesting authorization.

6. An electronically authorizing device according to claim 5, wherein said authorization result registration means registers, in the database, the result of authorization or repudiation for the object requesting authorization, and repudiation reasons when the repudiation is rendered.

7. An electronically authorizing device according to claim 6, wherein said authorization result reference means makes a reference to accumulated number of cases of authorization or repudiation and accumulated number of cases of the repudiated reasons within a predetermined term concerning the past results of authorization registered in the database.

8. An electronically authorizing device according to claim 6, wherein said authorization result reference means makes a reference to a ratio of the repudiated reasons during a predetermined term in the form of a chart concerning the past results of authorization registered in the database.

9. An electronically authorizing method comprising:
an authorization result registration process of registering a result of authorization in a database when an object requesting authorization is to be authorized or repudiated; and
an authorization result reference process of making a reference to the past results of authorization registered in the database for each object requesting authorization and for each person requesting authorization.

10. An electronically authorizing method according to claim 9, wherein said authorization result registration process registers, in the database, a result of authorization or repudiation for the object requesting authorization, and reasons of repudiation when the repudiation is rendered.

11. An electronically authorizing method according to claim 10, wherein said authorization result reference process makes a reference to accumulated number of cases of authorization or repudiation and accumulated number of cases of the repudiated reasons within a predetermined term concerning the past results of authorization registered in the database.

12. An electronically authorizing method according to claim 10, wherein said authorization result reference process makes a reference to a ratio of the repudiated reasons during a predetermined term in the form of a chart concerning the past results of authorization registered in the database.
